(19) United States
(12) Patent Application Publication
(10) Pub. No.: US 2005/0250471 A1
(43) Pub. Date: Nov. 10, 2005

(54) Method and communications device for electronically signing a message in a mobile radio telephone

(76) Inventor: Rudolf Philipeit, Ansbach (DE)

Correspondence Address: KENYON & KENYON, ONE BROADWAY, NEW YORK, NY, 10004, US

(21) Appl. No.: 10/511,921

(22) PCT Filed: Apr. 3, 2003
(86) PCT No.: PCT/DE03/01093

§ 371 Date: Apr. 13, 2005

(30) Foreign Application Priority Data
Apr. 17, 2002 (DE) 102 17 110.6

(51) Int. Cl. H04M 1/66

(52) U.S. Cl. 455/410; 455/411

(57) ABSTRACT

A method and communications system is provided for electronically signing a message in a mobile radio telephonehe invention. A personal computer can communicate directly with a mobile radio telephone which can act as a signing device, via a communications network. An electronic fingerprint is first generated from a message to be signed in a personal computer. The electronic fingerprint is sent by the personal computer via a communications network to a selectable mobile radio telephone, which contains a signing device. The received electronic fingerprint is signed in the mobile radio telephone and returned to the personal computer.

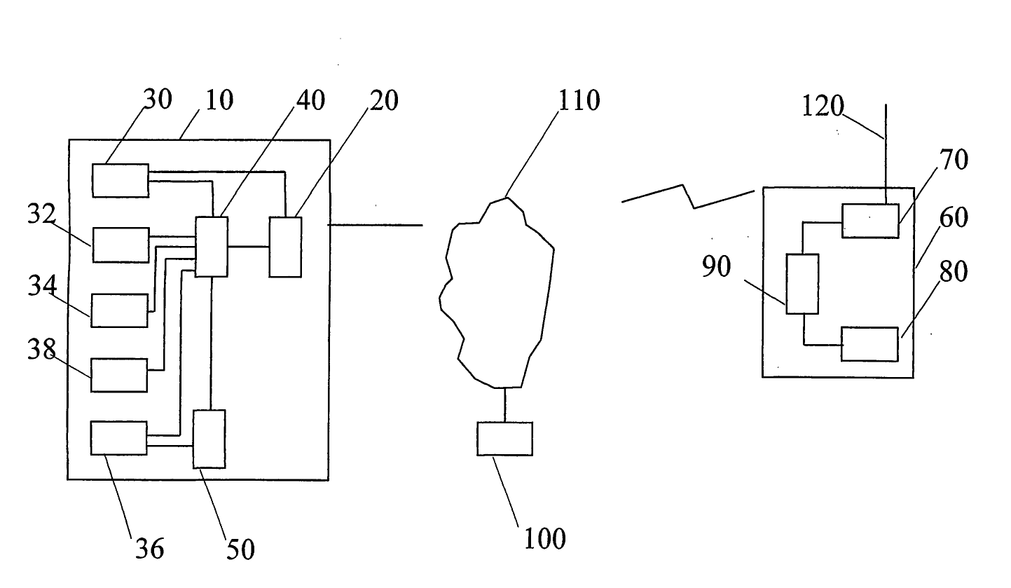

### FIELD OF THE INVENTION

The present invention relates to a method for electronically signing a message in a cellular phone, and to a communication system for implementing the method.

### BACKGROUND INFORMATION

In recent times, there has been a significant increase in the electronic transmission of documents, such as application forms and the like. To be able to verify the integrity of the transmitted data and the identity of the originator of the document, methods have been developed for digitally signing messages.

Such a method may be seen, for example, in reference DE 197 47 603 T2. In accordance with this method, a message to be signed is first sent from a personal computer via a communications network to a receiving device configured separately from the personal computer. This message is subsequently transmitted from the receiving device via a telephone network to a cellular phone assigned to the transmitting device, the cellular phone being designed as a signing device. The message is signed in the cellular phone by direction of the user and then retransmitted (transmitted) to the receiving device or to another receiver. In this method, the messages to be signed may be transmitted from a personal computer to a cellular phone functioning as a signing device, without requiring any installations or modifications to be made on the personal computer itself. However, this method requires a receiving device that is separate from the personal computer, that transmits the message to be signed to the cellular phone, and that can also receive the signed message back from the cellular phone.

This method may also be described in reference EP 1 027 784.

### SUMMARY OF THE INVENTION

The present invention provides a method and a communication system for electronically signing a message, which will enable a personal computer to communicate via a communications network directly with a cellular phone as a signing device.

Accordingly, a method is provided for electronically signing a message in a cellular phone. An electronic fingerprint of the message to be signed is first prepared in a personal computer and is subsequently transmitted via a communications network to any cellular phone which contains a signing device. The personal computer may be linked, for example, via an Internet access to the communications network. The received electronic fingerprint is signed in the cellular phone and then retransmitted to the personal computer.

To transmit the electronic fingerprint, software is implemented in the personal computer. It enables the electronic fingerprint to be transmitted via an SMS (short message service), e-mail or WAP (wireless application protocol) service.

The electronic signing may be carried out using any desired cryptographic method, such as the public-key method. To this end, a secret key, which cannot be copied, is first stored in the cellular phone, and a public key, assigned to the secret key, is stored in the personal computer. The public key may be a cryptographic key which is assigned to the owner of the cellular phone. Using the secret key, the cellular phone signs the electronic fingerprint and retransmits it to the personal computer. The personal computer, in turn, converts the signed electronic fingerprint using the public key into an unencrypted electronic fingerprint. To ascertain that there no manipulation of the transmitted electronic fingerprint has occurred on the unprotected transmission paths of the communications network, the signed electronic fingerprint, that had been converted into an unencrypted electronic fingerprint, is compared to the electronic fingerprint generated from the message to be signed. If the two electronic fingerprints match, it is ensured that no manipulation has taken place on the unprotected transmission paths between the personal computer and the cellular phone.

The electronic fingerprint may be generated in accordance with a generally known hash functions, from the message to be signed, and thus represents a specific hash value.

Accordingly, a communication system is defined which includes at least one personal computer that is able to be linked to a communications network, as well as at least one cellular phone assigned to the communications network. The personal computer contains a device for generating an electronic fingerprint from a message to be signed, as well as a transmitting device for transmitting the electronic fingerprint to any cellular phone. The cellular phone has a receiving device for receiving an electronic fingerprint transmitted by the personal computer via the communications network, a signing device for signing the received electronic fingerprint, as well as a transmitting device for retransmitting the signed electronic fingerprint to the personal computer.

Thus, for example, the cellular phone has a memory for storing a secret key, and the personal computer has a first memory for storing a public key assigned to the secret key. In this manner, the signing of a message may be implemented by using a public-key method. In addition, the personal computer has a device for converting a received, signed electronic fingerprint using the public key, as well as a comparator for comparing the converted electronic fingerprint to the electronic fingerprint generated from the message to be signed.

To be able to transmit the message to be signed, i.e., the electronic fingerprint generated from the message to be signed, from the personal computer to the cellular phone, and to be able to receive it again from the same, special communications software is to be implemented in the personal computer. This software may be stored in another memory.

In a further embodiment, the personal computer has a third memory in which at least the call number of the cellular phone is stored that the personal computer automatically dials when a message to be signed is to be signed by a cellular phone. The call numbers of other cellular phones or other signing devices that are reachable via the communications network, as well as the call number or call numbers of specific target devices, may likewise be stored in the third memory.

### BRIEF DESCRIPTION OF THE DRAWINGS

The FIGURE shows an embodiment of the present invention.

### DETAILED DESCRIPTION OF THE DRAWINGS

The FIGURE shows a personal computer 10, which may be linked via a communications network 110, for example, a cellular network, to a cellular phone (cellphone) 60. Using the exemplary communication system, a document created at personal computer 10 may be sent via communications network 110 to an addressee or target device 100.

For this purpose, personal computer 10 has an available transmitting/receiving device 20, via which personal computer 10 is linked to communications network 110. In a memory 30, one or more call numbers may be stored, which, in the present example, belong to cellphone 60 and to target device 100, to which a signed document is to be sent. To be able to sign or encrypt a document, for example, in accordance with the public-key method, as explained in greater detail further below, a so-called public key, which belongs to the owner of cell phone 60 and which is available to the public, is able to be stored in another memory 32. A document to be signed that has been created at personal computer 10, may be stored in a memory 34. It may be that it is not the completed document that is signed, but rather only an electronic fingerprint generated from the completed document. Such an electronic fingerprint may be calculated from the completed document, using a hash function, for example. The calculated value, also referred to as hash value, may be stored in a memory 36. To enable personal computer 10 to communicate via communications network 110 with cell phone 60, a suitable communications software is stored in a memory 38. The control of personal computer 10, the calculation of an electronic fingerprint from a completed document, and the decryption of an electronic fingerprint signed by cell phone 60 may take place in decentrally located devices or in a central control unit 40, as shown in the figure. Control unit 40 may communicate with memories 30, 32, 34, 36 and 38, as well as with transmitting/receiving device 20.

Besides a transmitting/receiving device 70 and an antenna 120, cellphone 60, provided with a signing function, has a signing device 90 which is linked to a memory 80, in which a secret key, e.g., the secret key of the owner of cellphone 60 is stored.

It is assumed here that a document created at personal computer 10, for example a purchase contract in signed form, is to be transmitted to target device 100. The document previously stored in document memory 34 is read out by control unit 40. Then, with the aid of a hash function, control unit 40 generates an electronic fingerprint from the document. This electronic fingerprint may be designated as the hash value. This hash value is stored in memory 36. Via a keyboard of personal computer 10, the user may now initiate the process of signing the requested document. To this end, a connection set-up to cell phone 60 is automatically initiated via communications network 110 in that the call number of cell phone 60 stored in memory 30 is read out and supplied to communications network 110 to be evaluated accordingly. Or, if there is a plurality of cell phones having the signing feature, the user himself/herself may also enter the call number of the cell phone in question via the keyboard of personal computer 10. The hash value stored in memory 36 is subsequently transmitted via transmitting/receiving device 20 of personal computer 10 via the communications network to cell phone 60. It is noted at this point that the transmission paths via communications network 110 are unprotected. Via transmitting/receiving device 70 of cell phone 60, the received hash value attains signing device 90. Signing device 90 and memory 80 may be permanently implemented in the cell phone or constitute part of a chip card which is insertable into the cell phone. To sign the received hash value, signing device 90 reads the secret key from memory 80 and encrypts or signs the hash value in accordance with the public-key method. The signed hash value is subsequently retransmitted via transmitting/receiving device 70 and antenna 120 that is schematically depicted in the figure, via communications network 110, directly back to personal computer 10. Via transmitting/receiving device 20, the signed hash value attains control unit 40, which, using the public key stored in memory 32, decrypts the signed hash value, i.e., reconverts it to the unencrypted hash value again. The decrypted hash value is then fed, together with the hash value that is stored in memory 36 and directly generated from the completed document, to comparator 50 and compared in this device. If the hash value stored in memory 36 and the decrypted hash value match, then no manipulation has taken place on the unprotected transmission paths of communications network 110 between personal computer 10 and cell phone 60. Thus, the document stored in memory 34, including the hash value stored in memory 36, is effectively signed; it may now be transmitted to addressee 100.

For this, a separate automatic dialer or control unit 40 reads the corresponding call number (or e-mail address, etc.) of target device 100 from memory 30 and establishes a connection to this number, provided that the addressee is connected to communications network 110. Finally, the signed document is transmitted to target device 100.

1-8. (canceled)

9. A method for electronically signing a message in a cellular phone, comprising:
generating an electronic fingerprint from the message to be signed, in a personal computer;
transmitting the electronic fingerprint from the personal computer via a communications network to the cellular phone having a signing device;
signing the received electronic fingerprint in the cellular phone; and
transmitting the signed electronic fingerprint from the cellular phone to the personal computer.

10. The method of claim 9, further comprising:
storing a secret key in the cellular phone; and
storing a public key assigned to the secret key in the personal computer,
wherein the electronic fingerprint is signed using the secret key in the cellular phone and is then transmitted to the personal computer, and the signed electronic fingerprint is converted using the public key into an unencrypted electronic fingerprint which is compared to the electronic fingerprint generated from the message to be signed.

11. The method of claim 10, wherein the electronic fingerprint is generated in accordance with a hash function from the message to be signed.

12. The method of claim 9,
wherein the electronic fingerprints are transmitted between the cellular phone and the personal computer using one of a Short Message Service (SMS), e-mail and Wireless Application Protocol (WAP) service.

13. A communication system for electronically signing, comprising:
at least one personal computer linkable to a communications network;
at least one cellular phone assigned to the communications network;
wherein the personal computer includes a device for generating an electronic fingerprint from a message to be signed, and a transmitting/receiving device for transmitting the electronic fingerprint to any cellular phone; wherein the cellular phone includes a receiving device for receiving an electronic fingerprint transmitted by the personal computer via the communications network, a signing device for signing the received electronic fingerprint, and a transmitting device for transmitting the signed electronic fingerprint to the personal computer.

14. The communication system of claim 13, wherein the cellular phone includes a memory for storing a secret key, and the personal computer includes a first memory for storing a public key assigned to the secret key, a device for converting a received, signed electronic fingerprint using the public key and a comparator for comparing the converted electronic fingerprint to the electronic fingerprint generated from the message to be signed.

15. The communication system of claim 13, wherein the personal computer includes a second memory for storing software which enables the personal computer to communicate with the cellular phone.

16. The communication system of claim 13, further comprising:
a third memory for storing the call numbers of at least one cellular phone and/or a target device; and
an automatic dial device for automatically dialing at least one of the cellular phone and a target device.
